(19) United States
(12) Patent Application Publication
(10) Pub. No.: US 2022/0274636 A1
(43) Pub. Date: Sep. 1, 2022

(54) TRAVELING DIRECTION STATE DETECTION DEVICE AND CART USING TRAVELING DIRECTION STATE DETECTION DEVICE

(71) Applicant: Shimizu Corporation, Tokyo (JP)

(72) Inventors: Yuji KINOSHITA, Tokyo (JP); Syunsuke IGARASHI, Tokyo (JP); Taku TANI, Tokyo (JP)

(73) Assignee: Shimizu Corporation, Tokyo (JP)

(21) Appl. No.: 17/629,790

(22) PCT Filed: Jul. 27, 2020
(86) PCT No.: PCT/JP2020/028752

§ 371 Date: Jan. 25, 2022

(30) Foreign Application Priority Data
Aug. 2, 2019 (JP) 2019-143389

(51) Int. Cl. B62B 5/00; G05D 1/02; G01C 9/06

(52) U.S. Cl. CPC B62B 5/0069; G05D 1/0223; G01C 9/06

(57) ABSTRACT

A traveling direction state detection device includes: a first distance sensor installed near a front side of the wheels in a traveling direction and configured to linearly measure a distance to a first linear position perpendicular to the traveling direction, the first linear position existing on the traveling surface diagonally downward in the traveling direction; a second distance sensor configured to linearly measure a distance to a second linear position perpendicular to the traveling direction, the second linear position existing on a traveling surface behind the traveling surface diagonally downward in the traveling direction, and ahead of ground contact points of the wheels; and a detector configured to detect a step, an inclination and an opening of the traveling surface based on an amount of change in the distances continuously measured by each of the first distance sensor and the second distance sensor at certain time intervals.

### FIELD

The present invention relates to a traveling direction state detection device that reliably detects a step, an inclination, and an opening of a traveling surface on which wheels travel, and a cart using the traveling direction state detection device.

### BACKGROUND

Conventionally, a device for detecting steps on a traveling surface on which a vehicle such as a cart travels has been known (refer to Patent Literature 1, for example). Such a device usually includes a distance sensor or the like installed vertically facing downward at a front part of the vehicle in the traveling direction, and detects a step by measuring the distance to the floor surface with this distance sensor or the like.

### CITATION LIST

### Patent Literature

Patent Literature 1: Japanese Patent Application Laid-open No. 2017-42223

### SUMMARY

### Technical Problem

However, in such a device, the distance from a tire (wheel) to the distance sensor needs to be set appropriately, taking into account a deceleration distance. When the distance between the tire and the distance sensor is short, the deceleration distance cannot be secured, resulting in the problem that the vehicle's moving speed must be reduced throughout the travel to accurately detect a step. There are also problems such as the possibility of not being able to detect the difference between a step and an inclined path, and the possibility of false detection when the vehicle is inclined.

Therefore, there has been a need for a high-performance device that can be applied even when the distance from a wheel to a distance sensor is short, and that can distinguish between a step and an inclined path.

When an opening is present in the traveling direction of a cart and in an area where its wheel passes, there is the possibility that the wheel may get stuck in the opening and become unable to travel.

The present invention has been made in view of the above problems, and an object of the present invention is to provide a traveling direction state detection device that reliably detects a step, an inclination, and an opening of a traveling surface on which wheels travel, and a cart using the device.

### Solution to Problem

To solve the above-described problem and achieve the object, a traveling direction state detection device according to the present invention for detecting a step, an inclination and an opening of a traveling surface on which wheels travel, includes: a first distance sensor installed near a front side of the wheels in a traveling direction and configured to linearly measure a distance to a first linear position perpendicular to the traveling direction, the first linear position existing on the traveling surface diagonally downward in the traveling direction; a second distance sensor configured to linearly measure a distance to a second linear position perpendicular to the traveling direction, the second linear position existing on a traveling surface behind the traveling surface diagonally downward in the traveling direction, and ahead of ground contact points of the wheels in the traveling direction; and a detector configured to detect a step, an inclination and an opening of the traveling surface based on an amount of change in the distances continuously measured by each of the first distance sensor and the second distance sensor at certain time intervals.

Moreover, a cart according to the present invention includes the traveling direction state detection device.

Moreover, a cart according to the present invention includes: the traveling direction state detection device according to any one of the above; and a controller configured to control a traveling speed of the cart, wherein the controller is configured to decelerate the traveling speed in a case where the amount of change in the distances measured by the first distance sensor exceeds a predetermined first threshold, and stop traveling of the cart in a case where the amount of change in the distances measured by the second distance sensor exceeds a predetermined second threshold.

Moreover, in the above-described cart according to the present invention, the controller is configured to decelerate the traveling speed in a case where only the amount of change in the distances in the traveling direction of at least one of the wheels among distances measured by the first distance sensor exceeds the predetermined first threshold, and stop the traveling of the cart in a case where only the amount of change in the distances in the traveling direction of at least one of the wheels among distances measured by the second distance sensor exceeds the predetermined second threshold.

### Advantageous Effects of Invention

According to the present invention, a step, an inclination, and an opening of a traveling surface on which wheels travel can be reliably detected.

### BRIEF DESCRIPTION OF DRAWINGS

FIG. 1 is an explanation drawing for explaining a schematic configuration of a traveling direction state detection device and a cart according to an embodiment of the present invention.

FIG. 2 is an explanation drawing for explaining a first linear position and a second linear position at which a long-distance sensor and a short-distance sensor scan with respective laser beams.

FIG. 3 is an explanation drawing illustrating detection states of a step.

FIG. 4 is an explanation drawing illustrating detection states of an inclination.

### DESCRIPTION OF EMBODIMENTS

The following describes in detail a traveling direction state detection device and a cart using the device, according to an embodiment of the present invention with reference to the drawings. Note that the present invention is not limited to this embodiment.

(Traveling Direction State Detection Device)

First, a traveling direction state detection device according to the present invention is described.

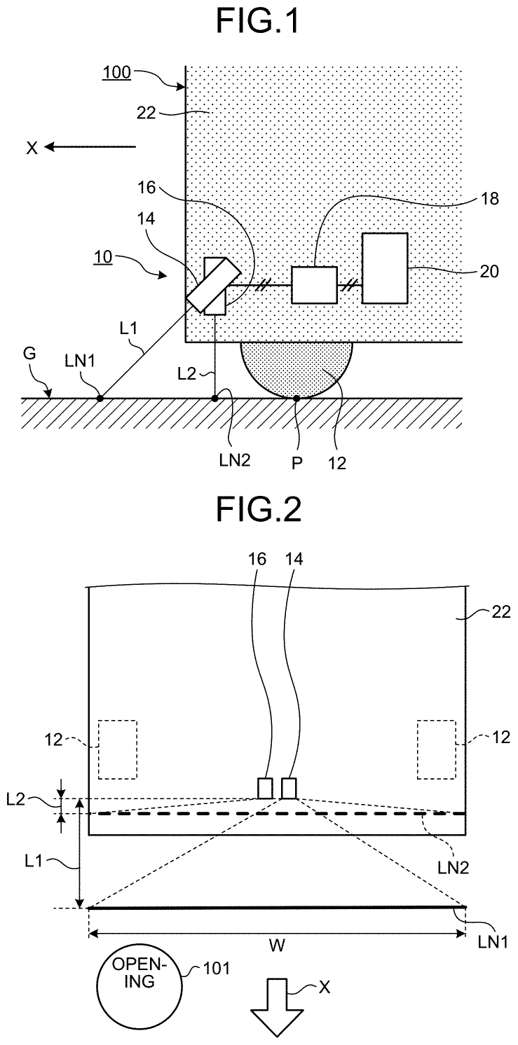

As illustrated in FIG. 1, a traveling direction state detection device 10 according to the present invention is a device for detecting a step, an inclination, and an opening of a traveling surface G on which wheels 12 travel. This traveling direction state detection device 10 includes a long-distance sensor 14 (first distance sensor), a short-distance sensor 16 (second distance sensor), and a detection unit 18, which are installed near the front side of the wheels 12 in a traveling direction X. The majority of the traveling surface G is horizontal, and a step, an inclination, which are not illustrated, or an opening 101 (refer to FIG. 2) is present on part of the traveling surface G.

As illustrated in FIG. 1 and FIG. 2, the long-distance sensor 14 and the short-distance sensor 16 are two-dimensional laser-scanner-type sensors that scan, with laser beams, the traveling surface G to be measured in a direction perpendicular to the traveling direction X, detect reflected light, and linearly calculate the distances to a first linear position LN1 and a second linear position LN2, respectively, perpendicular to the traveling direction X. The long-distance sensor 14 and the short-distance sensor 16 according to the present invention are not limited to the sensors described above, and ultrasonic sensors or other types of sensors, for example, may be used.

The long-distance sensor 14 is used to measure a distance L1 to the first linear position LN1 on the traveling surface G diagonally downward in the traveling direction X. The short-distance sensor 16 is used to measure a distance L2 to the second linear position LN2 on the traveling surface G vertically downward. The distance L1 measured by the long-distance sensor 14 is set to be relatively long, while the distance L2 measured by the short-distance sensor 16 is set to be relatively short (L1>L2). Thus, in the present embodiment, two distance sensors are installed near the front side of the wheels 12, one to measure vertically downward and the other to measure diagonally forward.

The distance to be measured by the short-distance sensor 16 is not limited to the distance to the second linear position LN2 on the traveling surface G vertically downward, but may be the distance to the second linear position LN2 on the traveling surface G behind the first linear position in the traveling direction X on the traveling surface G to be measured by the long-distance sensor 14 and ahead of ground contact points P of the wheels 12 in the traveling direction X. In other words, the second linear position LN2 on the traveling surface G slightly diagonally forward or diagonally backward from vertically downward may be used as a measurement target.

The detection unit 18 is used to detect a step, an inclination, and an opening of the traveling surface G based on the amount of change in the distances L1 and L2 that are continuously measured by the long-distance sensor 14 and the short-distance sensor 16, respectively, at certain time intervals. For example, a step is detected when the amount of change in the distances L2 measured by the short-distance sensor 16 exceeds a predetermined threshold, and an inclination is detected when the amount of change in the distances L1 measured by the long-distance sensor 14 exceeds a predetermined threshold.

The distance L1 measured by the long-distance sensor 14 is an average value of values converted to the distances from a straight line passing through an emitting position of the long-distance sensor 14 and perpendicular to the traveling direction X, to the first linear position LN1. Similarly, the distance L2 measured by the short-distance sensor 16 is an average value of values converted to the distances from a straight line passing through an emission position of the short-distance sensor 16 and perpendicular to the traveling direction X, to the second linear position LN2.

The long-distance sensor 14 and the short-distance sensor 16 store the distributions of the converted distances to the first linear position LN1 and the second linear position LN2, respectively, and in particular, when the amount of change in the distances in the traveling direction X of the wheels 12 exceeds a predetermined threshold, detect that there is the opening 101 in the traveling direction X of the wheels 12.

Scanning with the long-distance sensor 14 and the short-distance sensor 16 may be performed for at least a width W of the traveling surface G on which the wheels 12 travel.

(Detection Operation)

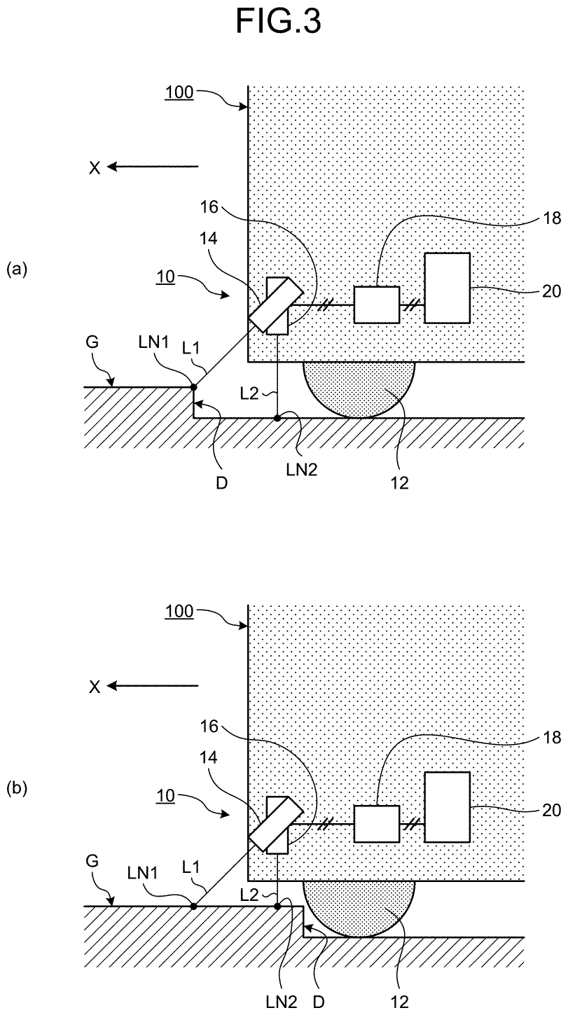

First, the following describes a case of detecting a step. FIG. 3(a) illustrates a state before detecting a step and FIG. 3(b) illustrates a state after detecting the step. As illustrated in FIG. 3, the distance L2 measured by the short-distance sensor 16 changes significantly at the moment of passing the step D. The detection unit 18 detects this as a large step when the amount of change exceeds a predetermined threshold.

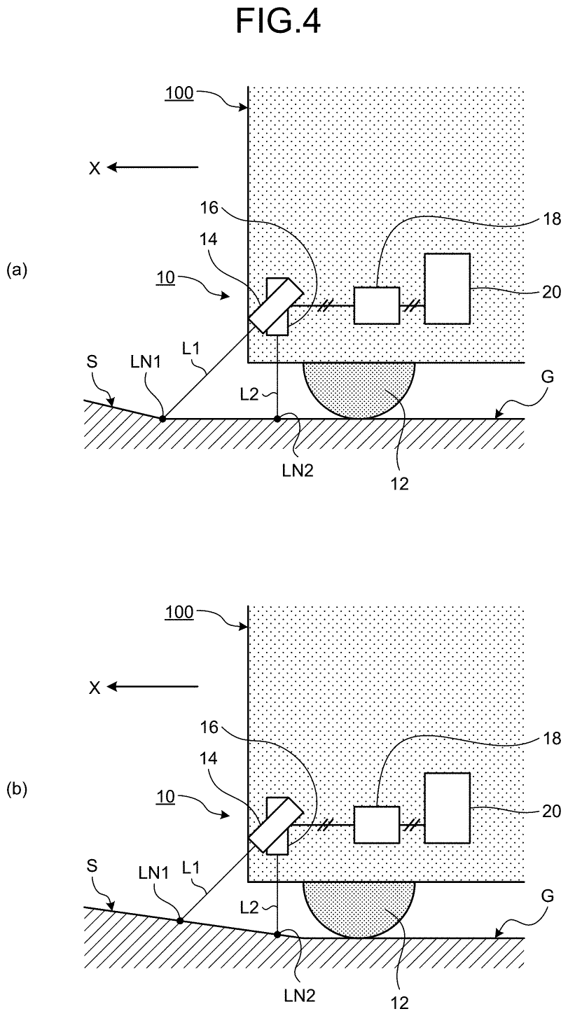

Next, the following describes a case of detecting an inclination. FIG. 4(a) illustrates a state before an inclination is detected and FIG. 4(b) illustrates a state after the inclination is detected. As illustrated in FIG. 4, the distance L1 measured by the long-distance sensor 14 changes slightly when the cart enters an inclined path S (slope) from the horizontal traveling surface G. The detection unit detects this as an inclined path (slope) or a small step when the amount of change exceeds a predetermined threshold.

Next, the following describes a case of detecting the opening 101. As illustrated in FIG. 2, when there is the opening 101 in the traveling surface G in the traveling direction X of the wheels 12, some of the distances to the first linear position LN1 and the second linear position LN2 measured by the long-distance sensor 14 and the short-distance sensor 16 change significantly. In FIG. 2, the amount of change in the distances in the traveling direction X of the wheels 12 varies greatly. The detection unit 18 detects the opening 101 when the amount of change in some of the distances to the first linear position LN1 and the second linear position LN2 exceeds a predetermined threshold. The detection unit 18 can also detect a projection other than the opening 101.

In this way, in the present embodiment, a large step is detected from a sudden change in the distances L2 measured by the short-distance sensor 16, and a small step or an inclined path is detected from a slight change in the distances L1 measured by the long-distance sensor 14. Also, an opening is detected from a sudden change in some of the distances L1 and L2 of the first linear position LN1 or the second linear position LN2. Thus, according to the present embodiment, a step, an inclination, and an opening can be distinguished and detected even when the distance from the wheels 12 to distance sensors (the long-distance sensor 14 and the short-distance sensor 16) is short. In addition, the present embodiment can be implemented with a simple configuration of two laser-scan-type distance sensors.

(Cart)

As illustrated in FIG. 1, a cart 100 according to the present invention includes the wheels 12, the traveling direction state detection device 10, and a control unit 20 that controls the traveling speed and other aspects of the cart 100. The wheels 12 each include a wheel (not illustrated) and a rubber tire mounted on the outer circumference of the wheel.

The cart 100 includes a cart body 22 that is rectangular in plan view, and the wheels 12 are provided at the four corners of the lower surface of the cart body 22. In the examples of FIG. 1 and FIG. 2, only the wheels 12 on the front side of the cart 100 are illustrated, and the other wheels 12 are not illustrated. The left and right wheels 12 on the rear side of the cart 100 are driving wheels for traveling, and the left and right wheels 12 on the front side are steering wheels. The present invention is not limited to this embodiment, and one of the front wheels or the rear wheels of the cart 100 may be driving-steering wheels that can be driven and steered, and the other may be steering wheels, or all the wheels 12 on the cart 100 may be driving-steering wheels. Furthermore, the number of wheels 12 on the cart 100 is not limited to four, and may be any other number of plural wheels.

On the basis of the values measured by the long-distance sensor 14 and the short-distance sensor 16, the control unit 20 controls the rotational speed of a traveling motor (not illustrated) to control the rotational drive of the wheels 12 (driving wheels) by the traveling motor, thereby controlling the traveling speed of the cart 100. More specifically, this control unit 20 controls the traveling speed of the cart 100 to decelerate when the amount of change in the distances L1 continuously measured by the long-distance sensor 14 at certain time intervals exceeds a predetermined first threshold. Furthermore, in this case, the control unit 20 controls the cart 100 to stop traveling when the amount of change in the distances L2 continuously measured by the short-distance sensor 16 at certain time intervals exceeds a predetermined second threshold. The second threshold is larger than the first threshold. The control unit 20 controls the traveling speed of the cart 100 to decelerate when the distance L1 continuously measured by the long-distance sensor 14 at certain time intervals, the distance L1 being of a part located in the traveling direction X of at least one of the wheels 12, exceeds the first threshold, and controls the cart 100 to stop traveling when the distance L2 continuously measured by the short-distance sensor 16 at certain time intervals, the distance L2 being of a part located in the traveling direction X of at least one of the wheels 12, exceeds the second threshold.

For this reason, the long-distance sensor 14 in the present embodiment functions as a deceleration distance sensor and the short-distance sensor 16 functions as a stopping distance sensor. Here, deceleration means slowing down the traveling speed of the cart 100 so that, for example, if the cart 100 is traveling at a speed of 30 km/h, it will travel at 15 km/h, and does not mean a gradual decrease in the speed of the cart 100.

The following describes an operation and an effect of the above configuration with reference to an example case in which the first threshold is set to 30 mm and the second threshold is set to 80 mm.

As illustrated in FIG. 4, when the amount of change in the distances L1 measured by the long-distance sensor 14 exceeds the first threshold (30 mm), the detection unit 18 of the traveling direction state detection device 10 detects it as a small step, a slope, or an opening. When this is detected, the control unit 20 performs deceleration control of the cart 100, reducing the traveling speed of the cart 100 to a speed that allows it to stop in a relatively short distance. When the first threshold (30 mm) is not exceeded, the speed is maintained.

On the other hand, as illustrated in FIG. 3, when the amount of change in the distances L2 measured by the short-distance sensor 16 exceeds the second threshold (80 mm), the detection unit 18 of the traveling direction state detection device 10 detects it as a large step or an opening. When this is detected, the control unit 20 controls the cart 100 to stop traveling (emergency stop). When the second threshold (80 mm) is not exceeded, the speed is maintained at the decelerated speed.

Therefore, according to the present embodiment, when the cart 100 travels on the traveling surface G having the inclined path S (slope) with a large inclination angle, a step D, or even the opening 101, the cart 100 can detect it in advance before the wheels 12 reach the inclined path S (slope), the step D, or the opening 101. Then, when the inclined path S (slope) is detected, the cart 100 can decelerate and continue traveling, and when the step D or the opening 101 is detected, the cart 100 can stop traveling (emergency stop). As a result, even when the distance from the wheels 12 to the distance sensors (the long-distance sensor 14 and the short-distance sensor 16) is short, it is no longer necessary to reduce the moving speed of the cart 100 over the entire travel, and the transport efficiency of the cart 100 can be improved.

### REFERENCE SIGNS LIST

10 Traveling direction state detection device
12 Wheel
14 Long-distance sensor (first distance sensor)
16 Short-distance sensor (second distance sensor)
18 Detection unit
20 Control unit
22 Cart body
100 Cart
101 Opening
D Step
G Traveling surface
L1, L2 Distance
LN1 First linear position
LN2 Second linear position
P Ground contact point
S Inclined path (slope)
X Traveling direction
W Width

1. A traveling direction state detection device for detecting a step, an inclination and an opening of a traveling surface on which wheels travel, comprising:
a first distance sensor installed near a front side of the wheels in a traveling direction and configured to linearly measure a distance to a first linear position perpendicular to the traveling direction, the first linear position existing on the traveling surface diagonally downward in the traveling direction;
a second distance sensor configured to linearly measure a distance to a second linear position perpendicular to the traveling direction, the second linear position existing on a traveling surface behind the traveling surface diagonally downward in the traveling direction, and ahead of ground contact points of the wheels in the traveling direction; and
a detector configured to detect a step, an inclination and an opening of the traveling surface based on an amount of change in the distances continuously measured by each of the first distance sensor and the second distance sensor at certain time intervals.

2. A cart comprising
the traveling direction state detection device according to claim 1.

3. A cart comprising:
the traveling direction state detection device according to claim 1; and
a controller configured to control a traveling speed of the cart, wherein
the controller is configured to
decelerate the traveling speed in a case where the amount of change in the distances measured by the first distance sensor exceeds a predetermined first threshold, and
stop traveling of the cart in a case where the amount of change in the distances measured by the second distance sensor exceeds a predetermined second threshold.

4. The cart according to claim 3, wherein
the controller is configured to decelerate the traveling speed in a case where only the amount of change in the distances in the traveling direction of at least one of the wheels among distances measured by the first distance sensor exceeds the predetermined first threshold, and
stop the traveling of the cart in a case where only the amount of change in the distances in the traveling direction of at least one of the wheels among distances measured by the second distance sensor exceeds the predetermined second threshold.
